(19) United States
(12) Patent Application Publication
(10) Pub. No.: US 2023/0337224 A1
(43) Pub. Date: Oct. 19, 2023

(54) METHOD FOR HANDLING HIGH-PRIORITY UPLINK TRANSMISSIONS AND USER EQUIPMENT

(71) Applicant: JRD COMMUNICATION (SHENZHEN) LTD., Shenzhen, Guangdong (CN)

(72) Inventors: Xiaoxue Yin, Shenzhen, Guangdong (CN); Jia Sheng, Shenzhen, Guangdong (CN)

(73) Assignee: JRD COMMUNICATION (SHENZHEN) LTD., Shenzhen, Guangdong (CN)

(21) Appl. No.: 17/905,336

(22) PCT Filed: Apr. 10, 2020
(86) PCT No.: PCT/CN2020/084195

§ 371 Date: Aug. 31, 2022

(51) Int. Cl. H04W 72/1268; H04W 72/566

(52) U.S. Cl. CPC H04W 72/1268; H04W 72/569

(57) ABSTRACT

A method for handling high-priority uplink (UL) transmissions is provided. The method includes: obtaining an earliest one of the high-priority UL transmissions which is satisfied with a timeline condition; combining the earliest one of the high-priority UL transmissions with at least one of the high-priority UL transmissions which is satisfied with the timeline condition and later than the earliest one of the high-priority UL transmissions to form a multiplexing channel; and dropping one of the high-priority UL transmissions which is not satisfied with the timeline condition and the multiplexed high-priority UL transmission, wherein the multiplexed high-priority UL transmission is obtained by combining the earliest one of the high-priority UL transmissions with at least one of the high-priority UL transmissions later than the earliest one of the high-priority UL transmissions. A user equipment device is also provided.

### TECHNICAL FIELD

The present disclosure relates to the field of communication systems, and more particularly, to a method for handling high-priority uplink (UL) transmissions and a user equipment.

### BACKGROUND

Ultra-reliable low-latency communication (URLLC) is one of several different types of use cases supported by the 5th generation wireless systems (5G) New Radio (NR) standard, as stipulated by 3rd Generation Partnership Project (3GPP) Release 15. URLLC is a communication service for successfully delivering packets with stringent requirements, particularly in terms of availability, latency, and reliability. URLLC will enable supporting emerging applications and services. Examples of the services include wireless control and automation in industrial factory environments, inter-vehicular communications for improved safety and efficiency, and the tactile internet. It is of importance for 5G especially considering the effective support of verticals which brings new business to the whole telecommunication industry.

One of the key features of URLLC is low latency. The low latency is important for gadgets that drive themselves or perform prostate surgeries. The low latency allows a network to be optimized for processing incredibly large amounts of data with minimal delay (or latency). The network needs to adapt to a broad amount of changing data in real time. 5G will enable this service to function. URLLC is the most promising addition to upcoming 5G capabilities, but it will also be the hardest to secure. URLLC requires a quality of service (QoS) totally different from mobile broadband services. It will provide networks with instantaneous and intelligent systems, though it will require transitioning out of a core network.

This new URLLC wireless connectivity will guarantee latency to be 1 millisecond (ms) or less. In order for this interface to achieve low latency, all the devices have to synchronize to the same time-base. Time-sensitive networking is another component of the 5G URLLC capabilities. This will allow the shapers used for managing traffic to be time aware.

The design of a low-latency and high-reliability service involves several components: integrated frame structure, incredibly fast turnaround, efficient control and data resource sharing, grant-free based uplink transmission, and advanced channel coding schemes. Uplink grant-free structures guarantee a reduction in a user equipment (UE) latency transmission through avoiding the middle-man process of acquiring a dedicated scheduling grant.

Recently, some overlapping uplink (UL) transmissions can be handled. Ina situation that a high-priority UL transmission overlaps with a low-priority UL transmission, the low-priority UL transmission is dropped under certain constraint. However, a solution for handling collisions between high-priority UL transmissions has not concluded.

### SUMMARY OF DISCLOSURE

A solution for handling collisions between high-priority UL transmissions has not concluded.

An object of the present disclosure is to provide a method for handling high-priority uplink (UL) transmissions. The method includes: obtaining an earliest one of the high-priority UL transmissions which is satisfied with a timeline condition; combining the earliest one of the high-priority UL transmissions with at least one of the high-priority UL transmissions which is satisfied with the timeline condition and later than the earliest one of the high-priority UL transmissions to form a multiplexing channel; and dropping one of the high-priority UL transmissions which is not satisfied with the timeline condition and a multiplexed high-priority UL transmission, wherein the multiplexed high-priority UL transmission is obtained by combining the earliest one of the high-priority UL transmissions with at least one of the high-priority UL transmissions later than the earliest one of the high-priority UL transmissions.

Another object of the present disclosure is to provide a method for handling high-priority uplink (UL) transmissions. The method includes: determining whether two adjacent ones of the high-priority UL transmissions are satisfied with a timeline condition; multiplexing the two adjacent ones of the high-priority UL transmissions when the two adjacent ones of the high-priority UL transmissions are satisfied with the timeline condition; and dropping one of the two adjacent ones of the high-priority UL transmissions when one of the two adjacent ones of the high-priority UL transmissions is not satisfied with the timeline condition.

Yet another object of the present disclosure is to provide a user equipment device, including: a transceiver; and a processor connected with the transceiver and configured to execute a method for handling high-priority uplink (UL) transmissions. Each of the high-priority UL transmissions overlaps with at least one of the high-priority UL transmissions. The method includes: obtaining an earliest one of the high-priority UL transmissions which is satisfied with a timeline condition; combining the earliest one of the high-priority UL transmissions with at least one of the high-priority UL transmissions which is satisfied with the timeline condition and later than the earliest one of the high-priority UL transmissions to form a multiplexing channel; and dropping one of the high-priority UL transmissions which is not satisfied with the timeline condition and a multiplexed high-priority UL transmission, wherein the multiplexed high-priority UL transmission is obtained by combining the earliest one of the high-priority UL transmissions with at least one of the high-priority UL transmissions later than the earliest one of the high-priority UL transmissions.

Yet another object of the present disclosure is to provide a user equipment device, including: a transceiver; and a processor connected with the transceiver and configured to execute a method for handling high-priority uplink (UL) transmissions. Each of the high-priority UL transmissions overlaps with at least one of the high-priority UL transmissions. The method includes: determining whether two adjacent ones of the high-priority UL transmissions are satisfied with a timeline condition; multiplexing the two adjacent ones of the high-priority UL transmissions when the two adjacent ones of the high-priority UL transmissions are satisfied with the timeline condition; and dropping one of the two adjacent ones of the high-priority UL transmissions when one of the two adjacent ones of the high-priority UL transmissions is not satisfied with the timeline condition.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable storage medium. The non-transitory computer readable storage medium, when loaded to a computer, directs a processor of the computer to execute the disclosed method.

The non-transitory computer readable storage medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product, that causes a computer to execute the disclosed method.

The disclosed method may be programmed as computer program, that causes a computer to execute the disclosed method.

The present disclosure provides a multiplexing and prioritization mechanism for high-priority uplink (UL) transmissions in an overlapping group. In the previous 3GPP RAN1 meetings, it has been agreed that, for handling the overlapped UL transmissions among low PHY priority channel/signals, the Release 15 mechanism will be used. Regarding the collisions between high-priority and low-priority UL transmissions, the low-priority UL transmission is dropped under certain constraint. However, there's no consensus on solutions for collisions between the high-priority UL transmissions. In the present disclosure, a new multiplexing mechanism is given to handling the collisions among the high-priority UL transmissions. In Rel-15, UCI multiplexing is performed for overlapping PUCCHs only if the timeline is satisfied. The case that overlapping PUCCHs do not satisfy the timeline is regarded as an error case. Nevertheless, the reliability of the high-priority UL transmissions needs to be guaranteed. The present disclosure provides a multiplexing and prioritization mechanism for handling this issue.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 illustrates a flowchart of a method for handling high-priority uplink (UL) transmissions in a user equipment (UE) according to one embodiment of the present disclosure.

FIG. 2 illustrates a timeline condition for handling the high-priority UL transmissions.

FIG. 3 illustrates another timeline condition for handling the high-priority UL transmissions

FIG. 4 illustrates a reserved high-priority UL transmission and a dropped high-priority UL transmission.

FIG. 5 illustrates a flowchart of a method for handling high-priority uplink (UL) transmissions in a user equipment (UE) according to another one embodiment of the present disclosure.

FIG. 6 illustrates a user equipment (UE) device according to an embodiment of the present disclosure.

FIG. 7 illustrates a block diagram of an example system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Fifth-generation (5G) wireless systems are generally a cellular communication system in a frequency range 2 (FR2) ranging from 24.25 GHz to 52.6 GHz, where multiplex transmit (Tx) and receive (Rx) beams are employed by a base station (BS) and/or a user equipment (UE) to combat a large path loss in a high frequency band. Due to hardware limitations and costs, the BS and the UE might only be equipped with a limited number of transmission and reception units (TXRUs).

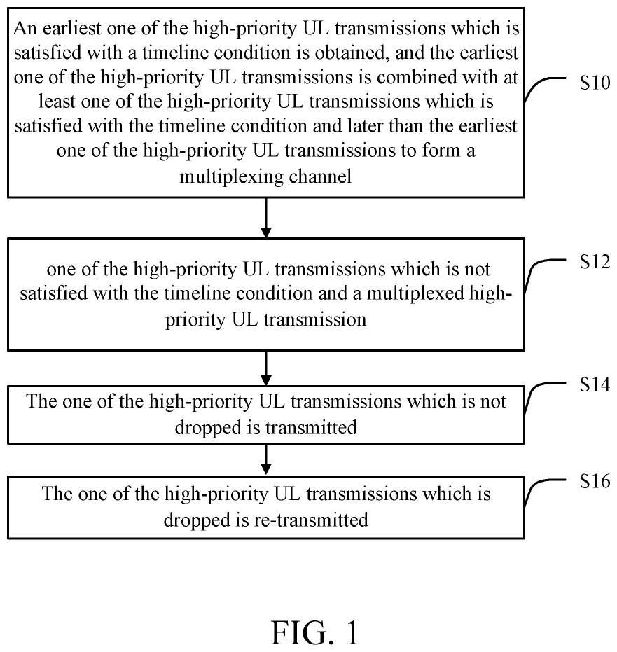

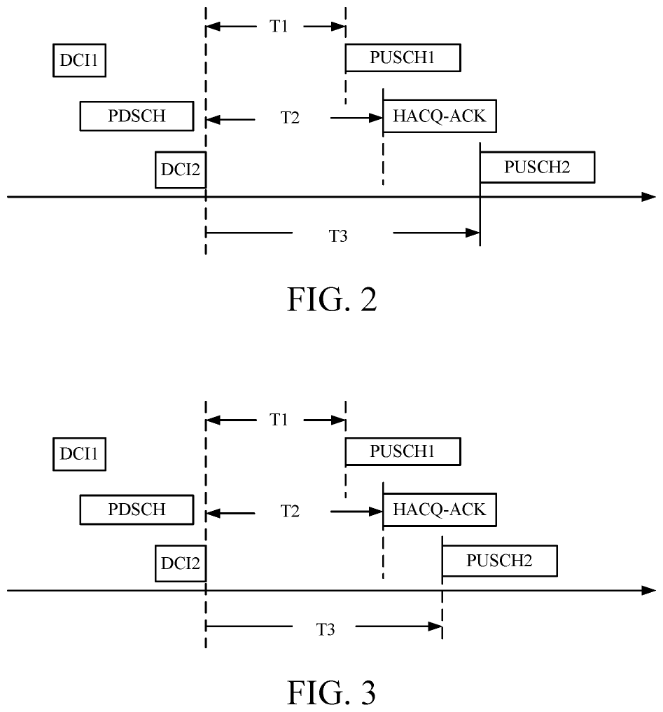

Please refer to FIG. 1 and FIG. 2. FIG. 1 illustrates a flowchart of a method for handling high-priority uplink (UL) transmissions in a user equipment (UE) according to one embodiment of the present disclosure. FIG. 2 illustrates a timeline condition for handling the high-priority UL transmissions. The high-priority UL transmissions are in an overlapping group as shown in FIG. 2. In detail, each of the high-priority UL transmissions overlaps with at least one of the high-priority UL transmissions. Each of the high-priority UL transmissions is one of a hybrid automatic repeat request ACK (HARQ-ACK), a scheduling request (SR), a physical uplink shared channel (PUSCH), a physical uplink control channel (PUCCH), and channel state information (CSI). The method for handling the high-priority UL transmissions includes the following steps.

In step S10, an earliest one of the high-priority UL transmissions which is satisfied with a timeline condition is obtained, and the earliest one of the high-priority UL transmissions is combined with at least one of the high-priority UL transmissions which is satisfied with the timeline condition and later than the earliest one of the high-priority UL transmissions to form a multiplexing channel.

In detail, all of the high-priority UL transmissions in the overlapping group which are later than the selected multiplexing channel could be multiplexed.

In the timeline condition, T₁≥T_{proc}^{mux}. T₁ is a time duration between a first symbol of the earliest one of the high-priority UL transmissions and a scheduling signal of a latest one of the high-priority UL transmissions. T_{proc}^{mux} is given by maximum of {T_{proc}^{mux1}, . . . , T_{proc}^{mux,i}, . . . }, where for an i-th physical downlink shared channel (PDSCH) or physical downlink control channel (PDCCH) corresponding to the PUCCH or the PUSCH in the overlapping group. T_{proc}^{mux,i} could be T_{proc,1}^{mux,i} or T_{proc,2}^{mux,i}. Release 15 mechanism could be used as baseline as defined in 3GPP 38.214.

As shown in FIG. 2, PUSCH1 overlaps with HARQ-ACK and does not overlap with PUSCH2, and HARQ-ACK overlaps with PUSCH 2. When PUSCH1, HARQ-ACK, and PUSCH2 are satisfied with the timeline condition, two multiplexing mechanism are provided. In one multiplexing mechanism, HARQ-ACK may be randomly multiplexed with PUSCH1 or PUSCH2. In the other multiplexing mechanism, HARQ-ACK may be multiplexed with PUSCH1 and then multiplexed with PUSCH2, thereby increasing robustness of the method.

In step S12, one of the high-priority UL transmissions which is not satisfied with the timeline condition and a multiplexed high-priority UL transmission is dropped. The multiplexed high-priority UL transmission is obtained by combining the earliest one of the high-priority UL transmissions with at least one of the high-priority UL transmissions later than the earliest one of the high-priority UL transmissions.

Please refer to FIG. 3. FIG. 3 illustrates another timeline condition for handling the high-priority UL transmissions. Two PUSCHs overlapping with one HARQ-ACK. PUSCH1 is scheduled by downlink control information 1 (DCI1). PUSCH2 is scheduled by DCI2. HARQ-ACK is in response to the physical downlink shared channel (PDSCH). Assuming that T₁<T_{proc}^{mux} and T₂≥T_{proc}^{mux}. An earliest one of the high-priority UL transmissions which is satisfied with the timeline condition is HARQ-ACK. The one of the high-priority UL transmissions which is not satisfied with the timeline condition is PUSCH1. Accordingly, prioritization is needed between PUSCH1 (the high-priority UL transmissions which is not satisfied with the timeline condition) and a multiplexed high-priority UL transmission of HARQ-ACK and PUSCH2 (the multiplexed high-priority UL transmission is obtained by combining HARQ-ACK with PUSCH2 and retains PUSCH2).

In one embodiment, a former one of the one (PUSCH1) of the high-priority UL transmissions which is not satisfied with the timeline condition and the multiplexed high-priority UL transmission (the multiplexed high-priority UL transmission of HARQ-ACK and PUSCH2) is dropped. That is, PUSCH1 is dropped.

In another embodiment, a latter one of the one (PUSCH 1) of the high-priority UL transmissions which is not satisfied with the timeline condition and the multiplexed high-priority UL transmission (the multiplexed high-priority UL transmission of HARQ-ACK and PUSCH2) is dropped. That is, the multiplexed high-priority UL transmission of HARQ-ACK and PUSCH2 is dropped.

In yet another embodiment, the one of the high-priority UL transmissions which is not satisfied with the timeline condition and the multiplexed high-priority UL transmission is dropped according to a predetermined priority table. The prioritization follows the priority table and guarantees the reliability of the most urgent and important high-priority UL transmission to be transmitted.

In one embodiment of the priority table, the priority order from high to low could be: HARQ-ACK>SR>PUSCH>CSI. As shown in FIG. 3, PUSCH1 is not satisfied with the timeline condition. Therefore, the prioritization is needed between PUSCH1 and the multiplexed high-priority UL transmission of HARQ-ACK and PUSCH2. According to the priority table, HARQ-ACK has higher priority than PUSCH2 and PUSCH 1, and thus PUSCH1 is dropped.

It is noted that the priority order of HARQ-ACK, SR, PUSCH, and CSI is not limited to above and may be designated randomly. Furthermore, CSI may be divided into aperiodic CSI (A-CSI), periodic CSI (P-CSI), and semi-persistent CSI (SP-CSI). PUSCH may be divided into dynamic grant-PUSCH (DG-PUSCH) and configured grant-PUSCH (CG-PUSCH).

In step S12, it is clear about which UL transmission needs to be dropped. However, the dropping action that which part or all of the high-priority UL transmission needs to be dropped is not clear.

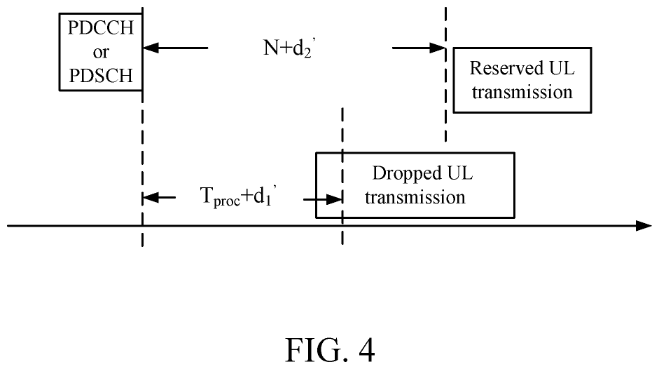

Please refer to FIG. 4. FIG. 4 illustrates a reserved high-priority UL transmission and a dropped high-priority UL transmission. The reserved high-priority UL transmission is a high-priority UL transmission which is not dropped in step S12. The dropped high-priority UL transmission is a high-priority UL transmissions which is dropped in step S12.

When a UE receives a PDCCH or PDSCH that triggers the reserved high-priority UL transmission, the UE cancels the dropped high-priority UL transmission which is determined to be cancelled in step S12, at latest starting T_{proc}+d′₁ symbols after an end of a last symbol of the PDCCH or PDSCH that triggers the reserved high-priority UL transmission. T_{proc} corresponds to UE processing time capability or PUSCH preparation time for a carrier, where:
T_{proc}=T_{proc,1} if the reserved high-priority UL transmission is a PUCCH comprising HARQ-ACK;
T_{proc}=T_{proc,2} if the reserved high-priority UL transmission is a PUSCH; or
T_{proc}=T_{proc,CSI} or T′_{proc,CSI} if the reserved high-priority UL transmission is a PUSCH comprising CSI report(s) or n-th CSI report, respectively.

Values d′₁ and d′₂ are time duration reported by UE capability. The simplest design is that d′₁=d₁ and d′₂=d₂·d₁ and d₂ are time duration corresponding to 0, 1, 2 symbols reported by UE capability. When the UE high priority capability supports finer capability definition, it could extend the time distance between the high-priority UL transmissions and give sufficient processing time for the reserved high-priority UL transmissions. For example, d′₁ and d′₂ could be extend corresponding to 0, 1, 2, 3, and 4 symbols reported by UE capability.

Assuming d2,1=0 and d2,2=0 for cancelation. The calculation of T_{proc,1}^{mux,i} and T_{proc,2}^{mux,i}, Release 15 mechanism could be used as baseline as defined in 3GPP 38.214 and 38.213.

In the present embodiment, the UE is not expected to be scheduled for the reserved high-priority UL transmission by the PDCCH or PDSCH where the reserved high-priority UL transmission starts earlier than N+d′₂ symbols after the end of the last symbol of the PDCCH or PDSCH, where:
N=T_{proc,1} if the reserved high-priority UL transmission is a PUCCH comprising HARQ-ACK;
N=T_{proc,2} if the reserved high-priority UL transmission is a PUSCH; or
N=T_{proc,CSI} or T′_{proc,CSI} if the reserved high-priority UL transmission is a PUSCH comprising CSI report(s) or n-th CSI report, respectively.

Please refer to FIG. 1. In another embodiment, the method for handling the high-priority UL transmissions further includes steps S14 and S16.

In step S14, the one of the high-priority UL transmissions which is not dropped is transmitted.

In step S16, the one of the high-priority UL transmissions which is dropped is re-transmitted.

In a situation that the earliest one (e.g., HARQ-ACK in FIG. 3) of the high-priority UL transmissions which is satisfied with the timeline condition is dropped, the one (e.g., PUSCH1 in FIG. 3) of the high-priority UL transmissions which is not satisfied with the timeline condition is transmitted, and then the earliest one (e.g., HARQ-ACK in FIG. 3) of the high-priority UL transmissions which is satisfied with the timeline condition is re-transmitted.

In a situation that the one (e.g., PUSCH1 in FIG. 3) of the high-priority UL transmissions which is not satisfied with the timeline condition is dropped, the earliest one (e.g., HARQ-ACK in FIG. 3) of the high-priority UL transmissions which is satisfied with the timeline condition is transmitted, and then the one (e.g., PUSCH1 in FIG. 3) of the high-priority UL transmissions which is not satisfied with the timeline condition is re-transmitted.

In one embodiment, all of the one of the high-priority UL transmissions is re-transmitted. In another embodiment, a cancelled part of the one of the high-priority UL transmissions is re-transmitted. In most scenarios, the overlapping parts do not occupy the entire dropped UL transmissions, retransmitting the cancelled part(s) of the dropped high-priority UL transmission can improve the resource utilization. When the dropped high-priority UL transmission is PUSCH with a certain amount of data information, retransmitting only the cancelled part(s) of the dropped high-priority UL transmission is more necessary.

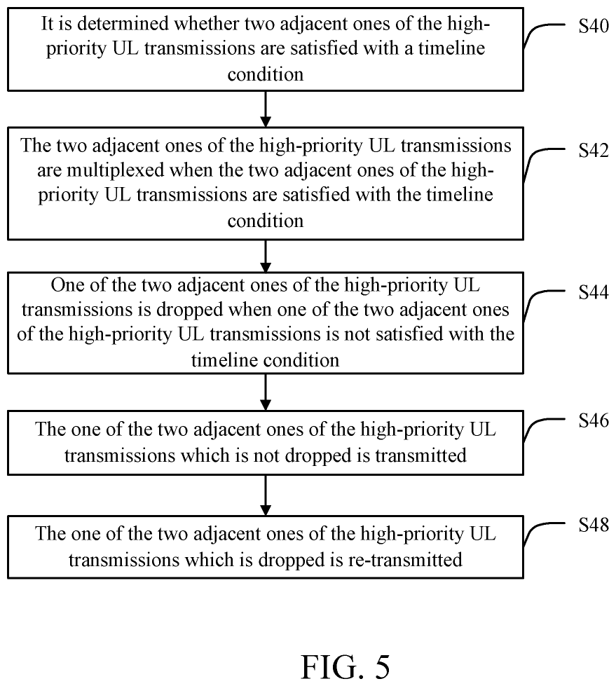

Please refer to FIG. 3 and FIG. 5. FIG. 5 illustrates a flowchart of a method for handling high-priority uplink (UL) transmissions in a user equipment (UE) according to another one embodiment of the present disclosure. The high-priority UL transmissions are in an overlapping group as shown in FIG. 3. In detail, each of the high-priority UL transmissions overlaps with at least one of the high-priority UL transmissions. Each of the high-priority UL transmissions is one of a hybrid automatic repeat request ACK (HARQ-ACK), a scheduling request (SR), a physical uplink shared channel (PUSCH), a physical uplink control channel (PUCCH), and channel state information (CSI).

In step 40, it is determined whether two adjacent ones of the high-priority UL transmissions are satisfied with a timeline condition. In the timeline condition, T₁≥T_{proc}^{mux}. T₁ is a time duration between a first symbol of the earliest one of the high-priority UL transmissions and a scheduling signal of a latest one of the high-priority UL transmissions. T_{proc}^{mux} is given by maximum of {T_{proc}^{mux,1}, . . . , T_{proc}^{mux,i}, . . . }, where for an i-th PDSCH (physical downlink shared channel) or PDCCH (physical downlink control channel) corresponding to the PUCCH or the PUSCH in the overlapping group. T_{proc}^{mux,i} could be T_{proc,1}^{mux,i} or T_{proc,2}^{mux,i} Release 15 mechanism could be used as baseline as defined in 3GPP 38.214.

In step S42, the two adjacent ones of the high-priority UL transmissions are multiplexed when the two adjacent ones of the high-priority UL transmissions are satisfied with the timeline condition.

In step S44, one of the two adjacent ones of the high-priority UL transmissions is dropped when one of the two adjacent ones of the high-priority UL transmissions is not satisfied with the timeline condition.

Please refer to FIG. 3 and FIG. 5. Two PUSCHs overlapping with one HARQ-ACK. PUSCH1 is scheduled by downlink control information 1 (DCI1). PUSCH2 is scheduled by DCI2. HARQ-ACK is in response to the physical downlink shared channel (PDSCH). Assuming that T₁<T_{proc}^{mux} and T₂≥T_{proc}^{mux}. One (PUSCH1) of the two adjacent ones (PUSCH1 and HARQ-ACK) of the high-priority UL transmissions is not satisfied with the timeline condition, and one (HARQ-ACK) of the two adjacent ones (PUSCH1 and HARQ-ACK) of the high-priority UL transmissions is dropped. Accordingly, prioritization is needed between PUSCH1 and HARQ-ACK.

In one embodiment, a former one (PUSCH1) of the two adjacent ones (PUSCH1 and HARQ-ACK) of the high-priority UL transmissions is dropped. That is, PUSCH1 is dropped.

In another embodiment, a latter one (HARQ-ACK) of the two adjacent ones (PUSCH1 and HARQ-ACK) of the high-priority UL transmissions is dropped. That is, HARQ-ACK is dropped.

In yet another embodiment, the one of the two adjacent ones (PUSCH1 and HARQ-ACK) of the high-priority UL transmissions is dropped according to a predetermined priority table. The prioritization follows the priority table and guarantees the reliability of the most urgent and important high-priority UL transmission to be transmitted.

In one embodiment of the priority table, the priority order from high to low could be: HARQ-ACK>SR>PUSCH>CSI. As shown in FIG. 3, PUSCH1 is not satisfied with the timeline condition. Therefore, the prioritization is needed between PUSCH1 and HARQ-ACK. According to the priority table, HARQ-ACK has higher priority, and thus PUSCH1 is dropped.

It is noted that the priority order of HARQ-ACK, SR, PUSCH, and CSI is not limited to above and may be designated randomly. Furthermore, CSI may be divided into aperiodic CSI (A-CSI), periodic CSI (P-CSI), and semi-persistent CSI (SP-CSI). PUSCH may be divided into dynamic grant-PUSCH (DG-PUSCH) and configured grant-PUSCH (CG-PUSCH).

In step S44, it is clear about which UL transmission needs to be dropped. However, the dropping action that which part or all of the high-priority UL transmission needs to be dropped is not clear.

Please refer to FIG. 4. The reserved high-priority UL transmission is one of the two adjacent ones (PUSCH1 and HARQ-ACK) of the high-priority UL transmissions which is satisfied with the timeline condition (e.g., HARQ-ACK in FIG. 3). The dropped high-priority UL transmission is one of the two adjacent ones of the high-priority UL transmissions which is not satisfied with the timeline condition (e.g., PUSCH1 in FIG. 3).

When a UE receives a PDCCH or PDSCH that triggers the reserved high-priority UL transmission, the UE cancels the dropped high-priority UL transmission which is determined to be cancelled in step S44, at latest starting T_{proc}+d′₁ symbols after an end of a last symbol of the PDCCH or PDSCH that triggers the reserved high-priority UL transmission. T_{proc} corresponds to UE processing time capability or PUSCH preparation time for a carrier, where:
T_{proc}=T_{proc,1} if the reserved high-priority UL transmission is a PUCCH comprising HARQ-ACK;
T_{proc}=T_{proc,2} if the reserved high-priority UL transmission is a PUSCH; or
T_{proc}=T_{proc,CSI} or T′_{proc,CSI} if the reserved high-priority UL transmission is a PUSCH comprising CSI report(s) or n-th CSI report, respectively.

Values d′₁ and d′₂ are time duration reported by UE capability. The simplest design is that d′₁=d₁ and d′₂=d₂·d₁ and d₂ are time duration corresponding to 0, 1, 2 symbols reported by UE capability. When the UE high priority capability supports finer capability definition, it could extend the time distance between the high-priority UL transmissions and give sufficient processing time for the reserved high-priority UL transmissions. For example, d′₁ and d′₂ could be extend corresponding to 0, 1, 2, 3, and 4 symbols reported by UE capability.

Assuming d2,1=0 and d2,2=0 for cancelation. The calculation of T_{proc,1}^{mux,i} and T_{proc,2}^{mux,i}, Release 15 mechanism could be used as baseline as defined in 3GPP 38.214 and 38.213.

In the present embodiment, the UE is not expected to be scheduled for the reserved high-priority UL transmission by the PDCCH or PDSCH where the reserved high-priority UL transmission starts earlier than N+d′₂ symbols after the end of the last symbol of the PDCCH or PDSCH, where:
N=T_{proc,1} if the reserved high-priority UL transmission is a PUCCH comprising HARQ-ACK;
N=T_{proc,2} if the reserved high-priority UL transmission is a PUSCH; or
N=T_{proc,CSI} or T′_{proc,CSI} if the reserved high-priority UL transmission is a PUSCH comprising CSI report(s) or n-th CSI report, respectively.

Please refer to FIG. 5. In another embodiment, the method for handling the high-priority UL transmissions further includes steps S46 and S48.

In step S46, the one of the two adjacent ones of the high-priority UL transmissions which is not dropped is transmitted.

In step S48, the one of the two adjacent ones of the high-priority UL transmissions which is dropped is re-transmitted.

In a situation that the one (e.g., HARQ-ACK in FIG. 3) of the two adjacent ones of the high-priority UL transmissions which is satisfied with the timeline condition is dropped, the one (e.g., PUSCH1 in FIG. 3) of the two adjacent ones of the high-priority UL transmissions which is not satisfied with the timeline condition is transmitted, and then the earliest one (e.g., HARQ-ACK in FIG. 3) of the two adjacent ones of the high-priority UL transmissions which is satisfied with the timeline condition is re-transmitted.

In a situation that the one (e.g., PUSCH1 in FIG. 3) of the two adjacent ones of the high-priority UL transmissions which is not satisfied with the timeline condition is dropped, the one (e.g., HARQ-ACK in FIG. 3) of the two adjacent ones of the high-priority UL transmissions which is satisfied with the timeline condition is transmitted, and then the one (e.g., PUSCH1 in FIG. 3) of the two adjacent ones of the high-priority UL transmissions which is not satisfied with the timeline condition is re-transmitted.

In one embodiment, all of the one of the high-priority UL transmissions is re-transmitted. In another embodiment, a cancelled part of the one of the high-priority UL transmissions is re-transmitted. In most scenarios, the overlapping parts do not occupy the entire dropped UL transmissions, retransmitting the cancelled part(s) of the dropped high-priority UL transmission can improve the resource utilization. When the dropped high-priority UL transmission is PUSCH with a certain amount of data information, retransmitting only the cancelled part(s) of the dropped high-priority UL transmission is more necessary.

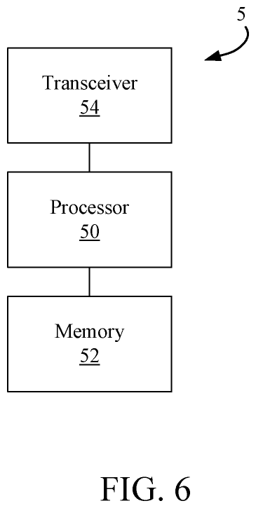

Please refer to FIG. 6. FIG. 6 illustrates a user equipment (UE) device 5 according to an embodiment of the present disclosure.

The UE device 5 may include a processor 50, a memory 52, and a transceiver 54. The processor 50 may be configured to implement proposed functions, procedures and/or methods described in this description. Layers of radio interface protocol may be implemented in the processor 50. The memory 52 operatively stores a variety of program and information to operate a connected processor. The transceiver 54 is operatively coupled with a connected processor, transmits and/or receives a radio signal.

The processor 50 may include an application-specific integrated circuits (ASICs), other chipsets, logic circuits and/or data processing devices. The memory 52 may include a read-only memory (ROM), a random access memory (RAM), a flash memory, a memory card, a storage medium and/or other storage devices. The transceiver 54 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The UE device 5 includes the processor 50 configured for executing a method for handling high-priority uplink (UL) transmissions.

In one embodiment, the method includes: obtaining an earliest one of the high-priority UL transmissions which is satisfied with a timeline condition; selecting the earliest one of the high-priority UL transmissions which is satisfied with the timeline condition as a multiplexing channel; and dropping one of the high-priority UL transmissions which is not satisfied with the timeline condition and a multiplexed high-priority UL transmission, wherein the multiplexed high-priority UL transmission is obtained by combining the earliest one of the high-priority UL transmissions which is satisfied with the timeline condition with at least one of the high-priority UL transmissions later than the earliest one of the high-priority UL transmissions which is satisfied with the timeline condition.

In another embodiment, the method includes: determining whether two adjacent ones of the high-priority UL transmissions are satisfied with a timeline condition; multiplexing the two adjacent ones of the high-priority UL transmissions when the two adjacent ones of the high-priority UL transmissions are satisfied with the timeline condition; and dropping one of the two adjacent ones of the high-priority UL transmissions when one of the two adjacent ones of the high-priority UL transmissions is not satisfied with the timeline condition.

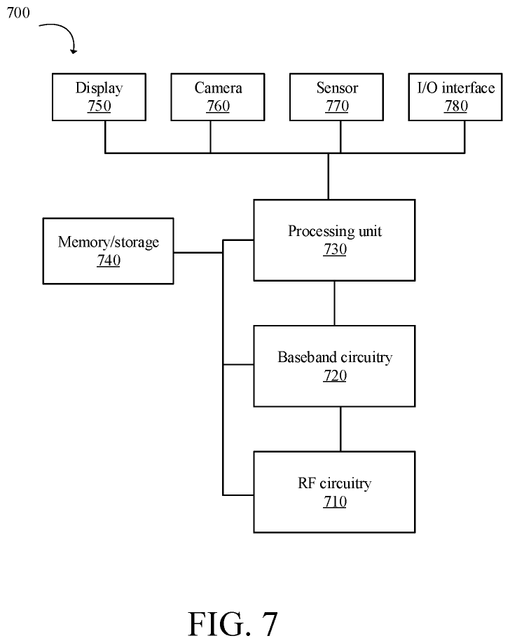

Please refer to FIG. 7. FIG. 7 illustrates a block diagram of an example system 700 for wireless communication according to an embodiment of the present disclosure. Embodiments described herein may be implemented into the system using any suitably configured hardware and/or software. FIG. 7 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The disclosed method provides flexible QoS management based on sidelink traffic types. Sidelink transmission of each traffic type may have configurable priority to meet different communication cases and QoS requirements according to the disclosure.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for handling high-priority uplink (UL) transmissions, each of the high-priority UL transmissions overlapping with at least one of the high-priority UL transmissions, the method comprising:
obtaining an earliest one of the high-priority UL transmissions which is satisfied with a timeline condition;
combining the earliest one of the high-priority UL transmissions with at least one of the high-priority UL transmissions which is satisfied with the timeline condition and later than the earliest one of the high-priority UL transmissions to form a multiplexing channel; and
dropping one of the high-priority UL transmissions which is not satisfied with the timeline condition and a multiplexed high-priority UL transmission, wherein the multiplexed high-priority UL transmission is obtained by combining the earliest one of the high-priority UL transmissions with at least one of the high-priority UL transmissions later than the earliest one of the high-priority UL transmissions.

2. The method of claim 1, wherein a former one of the one of the high-priority UL transmissions which is not satisfied with the timeline condition and the multiplexed high-priority UL transmission is dropped.

3. The method of claim 1, wherein a latter one of the one of the high-priority UL transmissions which is not satisfied with the timeline condition and the multiplexed high-priority UL transmission is dropped.

4. The method of claim 1, wherein the one of the high-priority UL transmissions which is not satisfied with the timeline condition and the multiplexed high-priority UL transmission is dropped according to a predetermined priority table.

5. The method of claim 4, wherein a priority order from high to low is a hybrid automatic repeat request ACK (HARQ-ACK)>a scheduling request (SR)>a physical uplink control channel (PUCCH)>channel state information (CSI).

6. The method of claim 1, wherein in the timeline condition, T₁≥T_{proc}^{mux}, T₁ is a time duration between a first symbol of the earliest one of the high-priority UL transmissions and a scheduling signal of a latest one of the high-priority UL transmissions, T_{proc}^{mux} is given by maximum of {T_{proc}^{mux,1}, . . . , T_{proc}^{mux,i}, . . . }, where for an i-th physical downlink shared channel (PDSCH) or physical downlink control channel (PDCCH) corresponding to a physical uplink control channel (PUCCH) or a physical uplink shared channel (PUSCH) in the overlapping group.

7. The method of claim 1, further comprising:
transmitting the one of the high-priority UL transmissions which is not dropped; and
re-transmitting the one of the high-priority UL transmissions which is dropped, wherein all or a cancelled part of the one of the high-priority UL transmissions which is dropped is re-transmitted.

8. A method for handling high-priority uplink (UL) transmissions, each of the high-priority UL transmissions overlapping with at least one of the high-priority UL transmissions, the method comprising:
determining whether two adjacent ones of the high-priority UL transmissions are satisfied with a timeline condition;
multiplexing the two adjacent ones of the high-priority UL transmissions when the two adjacent ones of the high-priority UL transmissions are satisfied with the timeline condition; and
dropping one of the two adjacent ones of the high-priority UL transmissions when one of the two adjacent ones of the high-priority UL transmissions is not satisfied with the timeline condition.

9. The method of claim 8, wherein a former one of the two adjacent ones of the high-priority UL transmissions is dropped.

10. The method of claim 8, wherein a latter one of the two adjacent ones of the high-priority UL transmissions is dropped.

11. The method of claim 8, wherein the one of the two adjacent ones of the high-priority UL transmissions is dropped according to a predetermined priority table.

12. The method of claim 11, wherein a priority order from high to low is a hybrid automatic repeat request ACK (HARQ-ACK)>a scheduling request (SR)>a physical uplink control channel (PUCCH)>channel state information (CSI).

13. The method of claim 8, wherein in the timeline condition, T₁≥T_{proc}^{mux}, T₁ is a time duration between a first symbol of the earliest one of the high-priority UL transmissions and a scheduling signal of a latest one of the high-priority UL transmissions, T_{proc}^{mux} is given by maximum of {T_{proc}^{mux,1}, . . . , T_{proc}^{mux,i}, . . . }, where for an i-th physical downlink shared channel (PDSCH) or physical downlink control channel (PDCCH) corresponding to a physical uplink control channel (PUCCH) or a physical uplink shared channel (PUSCH) in the overlapping group.

14. The method of claim 8, further comprising:
transmitting the one of the two adjacent ones of the high-priority UL transmissions which is not dropped; and
re-transmitting the one of the two adjacent ones of the high-priority UL transmissions which is dropped, wherein all or a cancelled part of the one of the high-priority UL transmissions which is dropped is re-transmitted.

15. A user equipment device, comprising:
a transceiver; and
a processor connected with the transceiver and configured to execute a method for handling high-priority uplink (UL) transmissions, each of the high-priority UL transmissions overlapping with at least one of the high-priority UL transmissions, the method comprising:
obtaining an earliest one of the high-priority UL transmissions which is satisfied with a timeline condition;
combining the earliest one of the high-priority UL transmissions with at least one of the high-priority UL transmissions which is satisfied with the timeline condition and later than the earliest one of the high-priority UL transmissions to form a multiplexing channel; and
dropping one of the high-priority UL transmissions which is not satisfied with the timeline condition and a multiplexed high-priority UL transmission, wherein the multiplexed high-priority UL transmission is obtained by combining the earliest one of the high-priority UL transmissions with at least one of the high-priority UL transmissions later than the earliest one of the high-priority UL transmissions.

16. The user equipment device of claim 15, wherein a former one of the one of the high-priority UL transmissions which is not satisfied with the timeline condition and the multiplexed high-priority UL transmission is dropped.

17. The user equipment device of claim 15, wherein a latter one of the one of the high-priority UL transmissions which is not satisfied with the timeline condition and the multiplexed high-priority UL transmission is dropped.

18. The user equipment device of claim 15, wherein the one of the high-priority UL transmissions which is not satisfied with the timeline condition and the multiplexed high-priority UL transmission is dropped according to a predetermined priority table, and a priority order from high to low is a hybrid automatic repeat request ACK (HARQ-ACK)>a scheduling request (SR)>a physical uplink control channel (PUCCH)>channel state information (CSI).

19. (canceled)

20. The user equipment device of claim 15, in the timeline condition, T₁≥T_{proc}^{mux}, T₁ is a time duration between a first symbol of the earliest one of the high-priority UL transmissions and a scheduling signal of a latest one of the high-priority UL transmissions, T_{proc}^{mux} is given by maximum of {T_{proc}^{mux,1}, . . . , T_{proc}^{mux,i}, . . . }, where for an i-th physical downlink shared channel (PDSCH) or physical downlink control channel (PDCCH) corresponding to a physical uplink control channel (PUCCH) or a physical uplink shared channel (PUSCH) in the overlapping group.

21. The user equipment device of claim 15, wherein the processor is further configured to execute the following steps comprising:
transmitting the one of the high-priority UL transmissions which is not dropped; and
re-transmitting the one of the high-priority UL transmissions which is dropped, wherein all or a cancelled part of the one of the high-priority UL transmissions which is dropped is re-transmitted.

22-36. (canceled)
